(19) United States
(12) Patent Application Publication
(10) Pub. No.: US 2010/0050270 A1
(43) Pub. Date: Feb. 25, 2010

(54) Control of Access to Content Received from a Multimedia Content Distribution Network

(75) Inventors: James Pratt, Round Rock, TX (US); Steven M. Belz, Cedar Park, TX (US); Marc Sullivan, Austin, TX (US)

Correspondence Address: AT&T Legal Department - JW;Attn: Patent Docketing, Room 2A-207, One AT&T Way, Bedminster, NJ, 07921, US

(73) Assignee: AT&T InteIlectual Property I, L.P., Reno, NV (US)

(21) Appl. No.: 12/195,269

(22) Filed: Aug. 20, 2008

(51) Int. Cl. H04K 1/00

(52) U.S. Cl. 726/28

(57) ABSTRACT

A disclosed method for controlling access to content provided by a multimedia content delivery network includes detecting a remote control signal, determining identification information and action information in the remote control signal, generating a CPE code based on a combination of the identification and action information, and performing a content control action based on the CPE code. The identification information may indicate a setting of a switch of the remote control device or a user of the remote control device. Generating the CPE code may include generating a first CPE code when the identification information indicates a first user and generating a different CPE code when the identification information indicates a second user. Generating the CPE code may still further include accessing parental control restrictions associated with a user or user class indicated by the identification information and generating a CPE code in compliance with the parental control restrictions.

### BACKGROUND

1. Field of the Disclosure

The present disclosure relates to multimedia content delivery networks and, more particularly, controlling access to content provided by such networks.

2. Description of the Related Art

In the field of television (TV) and other multimedia and entertainment applications, features exist to give parents or others with supervisory roles limited control over content that children may listen to, watch, or both. The V-chip, for example, enables parents to use TV ratings as a rough proxy for acceptable and unacceptable children's content.

### BRIEF DESCRIPTION OF THE DRAWINGS

FIG. 1 is a block diagram of selected elements of an embodiment of a multimedia distribution network;

FIG. 2 is a block diagram of selected elements of an embodiment of a multimedia handling device;

FIG. 3 is a block diagram of selected elements of an embodiment of a remote control device;

FIG. 4 illustrates an embodiment of a method of processing a remote control signal; and

FIG. 5 illustrates another embodiment of a method of processing a remote control signal.

### DESCRIPTION OF THE EMBODIMENT(S)

In one aspect, a disclosed method for controlling access to content provided by a multimedia content delivery network includes detecting a remote control signal, identifying identification information and action information in the remote control signal, generating a customer premises equipment (CPE) code based on a combination of the identification information and the action information, and performing a content control action based on a value of the CPE code. The identification information may be indicative of a setting of a switchable control of a remote control device or a user of the remote control device. In some embodiments, the method includes generating a CPE code corresponding to the action information when the identification information is indicative of a first user and performing a null action when the identification information is indicative of a second user. Generating the CPE code may include generating a first CPE code when the identification information is indicative of a first user and generating a second CPE code, different than the first CPE code, when the identification information is indicative of a second user. Generating CPE codes may also include querying a database of CPE codes using the identification information and the action information as query parameters. Generating the CPE code may still further include accessing parental control restrictions associated with a user or user class indicated by the identification information. Generating the CPE code may include generating a CPE code in compliance with the parental control restrictions.

In another aspect, a disclosed CPE device includes a general purpose processor, a network interface to receive encoded multimedia content, a multimedia decoder to decode the encoded multimedia content, a remote control interface to receive and process a remote control signal transmitted by a remote control; and storage media embedding processor executable instructions. The instructions may include instructions to perform the following operations. Extracting, from the remote control signal, identification information indicating a setting of a remote control device and extracting, from the remote control signal, action information indicative of a requested action. The operations may further include determining a CPE action based on the identification information and the action information and executing the CPE action. The operations may further include operations to generate a CPE code corresponding to the CPE action. The storage media may further include CPE code data. The CPE code data may be suitable for determining the CPE code corresponding to a CPE action. The instructions to generate the CPE code may include instructions to access the CPE code data structure using the CPE action. The instructions to determine a CPE action may include instructions to determine a null action as the CPE action when the identification information has a first value. The identification information may convey the identity of a remote control device, a state of an N-state switchable control of the remote control device, or a user category of a user of the remote control device. The user categories may include an adult category and a child category. Determining the CPE action may include accessing parental control information when the user category is the child category and identifying a CPE action complying with the parental control information.

In still another aspect, an embodiment of a disclosed remote control device includes an N-state switchable control where N is a variable having a value greater than 1, a plurality of action controls, and data generation logic configured to respond to an assertion of an action control, by generating remote control data based on the action control asserted and a state of the N-state switchable control. The remote control device may further include a transmitter operable to modulate the remote control data onto a remote control carrier signal and transmit the modulated remote control carrier signal. The switchable control is a physical switch or a “soft” switch. The physical switch may be recessed within a housing of the remote control device or otherwise located where the physical switch is not easily asserted. The device may include a sensing device to detect a biometric characteristic of a user. A state of the N-state switchable control may reflect a biometric characteristic detected by the sensing device. The remote control data may include a numeric action code based on the asserted action control and a numeric identification code based on a state of the N-state switchable control. The modulated remote control carrier signal may include an action code portion indicative of the action code and an identification portion indicative of the identification code.

In the following description, details are set forth by way of example to facilitate discussion of the disclosed subject matter. It should be apparent to a person of ordinary skill in the field, however, that the disclosed embodiments are exemplary and not exhaustive of all possible embodiments. Throughout this disclosure, a hyphenated form of a reference numeral refers to a specific instance of an element and the un-hyphenated form of the reference numeral refers to the element generically or collectively. Thus, for example, widget 12-1 refers to an instance of a widget class, which may be referred to collectively as widgets 12 and any one of which may be referred to generically as a widget 12.

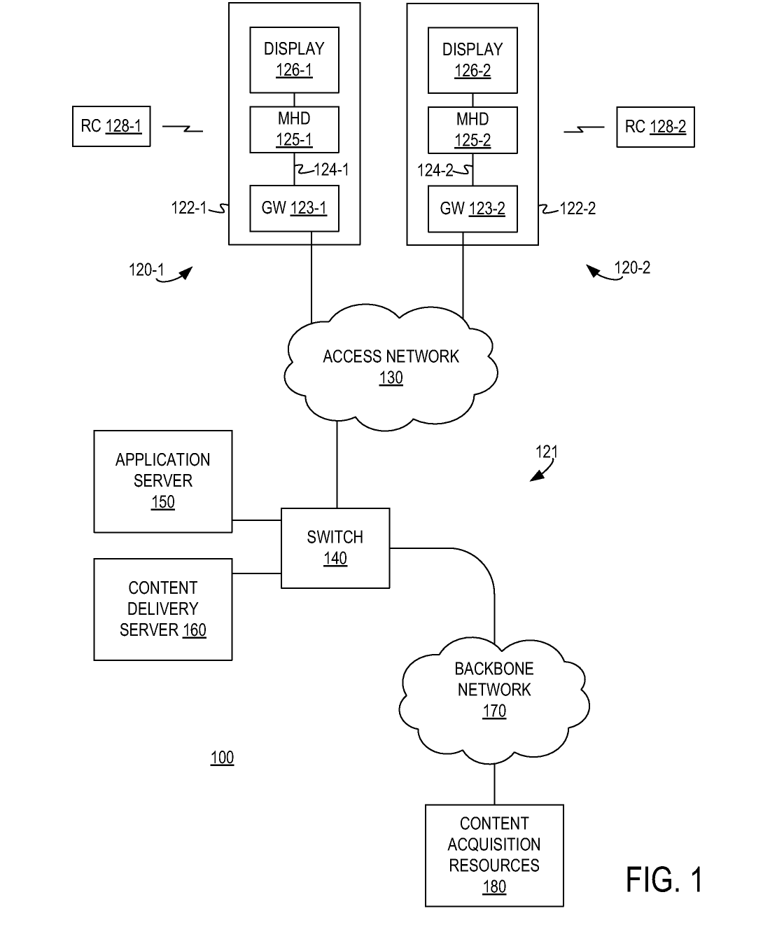

Turning now to the drawings, FIG. 1 is a block diagram illustrating selected elements of an embodiment of a multimedia content delivery network (MCDN) 100. The depicted embodiment of MCDN 100 includes or supports functionality enabling an administrative user such as a parent to control or otherwise manage another user's access to multimedia content. Although multimedia content is not limited to TV, video on demand (VOD), or pay-per-view programs, the depicted embodiments of MCDN 100 and its capabilities are described herein with primary reference to these types of multimedia content, which are interchangeably referred to herein as multimedia content program(s), multimedia programs or, simply, programs.

The elements of MCDN 100 illustrated in FIG. 1 emphasize the network's functionality for delivering multimedia content to a set of one or more subscribers. As depicted in FIG. 1, MCDN 100 includes one or more clients 120 and a service provider 121. Each client 120 may represent a different subscriber of MCDN 100. Service provider 121 as depicted in FIG. 1 encompasses resources to acquire, process, and deliver programs to clients 120.

Clients 120 and service provider 121 are demarcated by an access network 130 to which clients 120 and service provider 121 are connected. In some embodiments, access network 130 is an Internet protocol (IP) compliant network. In other embodiments including, as an example, coaxial cable networks, access network 130 may not be an IP network.

In IP-compliant embodiments of access network 130, access network 130 may include a physical layer of unshielded twist pair cables, fiber optic cables, or both. MCDN 100 may include digital subscribe line (DSL) compliant twisted pair connections between clients 120 and a node (not depicted) in access network 130 while fiber cable or another broadband medium connects service provider resources to a node in access network 130. In other embodiments, the broadband cable may extend all the way to clients 120.

The clients 120 depicted in FIG. 1 include a network appliances collectively referred to herein as CPE 122. In the depicted embodiment, CPE 122 includes three separate devices, namely, a gateway (GW) 123, a multimedia handling device (MHD) 125, and a display device 126. Any combination of GW 123, MHD 125, and display device 126 may be integrated into a single physical device. Thus, for example, CPE 122 might include a single physical device that integrates GW 123, MHD 125, and display device 126. As another example, MHD 125 may be integrated into display device 126.

GW 123 provides an interface and conversion function between access network 130 and a client-side local area network (LAN) 124. GW 123 may include elements of a conventional DSL or cable modem. GW 123, in some embodiments, may further include routing functionality for routing multimedia content, conventional data content, or a combination of both in compliance with IP or another network layer protocol. In some embodiments, LAN 124 may encompass or represent an IEEE 802.3 (Ethernet) LAN, an IEEE 802.11-type (WiFi) LAN, or a combination thereof GW 123 may still further include WiFi or another type of wireless access point to extend LAN 124 to wireless-capable devices in proximity to GW 123. GW 123 may also provide a firewall (not depicted) between clients 120 and access network 130.

Clients 120 as depicted in FIG. 1 further include a display device or, more simply, a display 126. Display 126 may be implemented as a TV, a liquid crystal display screen, a computer monitor, or the like. Display 126 may comply with a display standard such as NTSC (National Television System Committee), PAL (Phase Alternating Line), or another suitable standard. Display 126 may include one or more integrated speakers to play audio content.

Remote control 128 of client 120 is operable to communicate requests or commands wirelessly to MHD 125 using infrared (IR) or radio frequency (RF) signals as is well known. MHDs 125 may also receive requests or commands via buttons (not depicted) located on side panels of MHDs 125.

MHD 125 is enabled and configured to process incoming multimedia signals to produce audio and visual signals suitable for delivery to display 126 and any optional external speakers (not depicted). Incoming multimedia signals received by MHD 125 may be compressed and/or encrypted, digital or analog, packetized for delivery over packet switched embodiments of access network 130 or modulated for delivery over cable-based access networks. In some embodiments, MHD 125 may be implemented as a stand-alone set top box suitable for use in a co-axial or IP-based multimedia content delivery network.

As depicted FIG. 1, the elements representing service provider 121 include content acquisition resources 180 connected to a switch 140 via a backbone network 170. An application server 150 and a content delivery server 160 are also shown connected to switch 140. Switch 140 may provide firewall and routing functions to demarcate access network 130 from the resources of service provider 121. Switch 140 may be housed in a central office or other facility of service provider 121. In embodiments that employ DSL compliant connections, switch 140 may include elements of a DSL Access Multiplexer (DSLAM) that multiplexes many subscriber DSLs to backbone network 170. Backbone network 170 represents a private network including, as an example, a fiber based network to accommodate high data transfer rates. Content acquisition resources 180 as depicted in FIG. 1 encompass the acquisition of various types of content including broadcast content, other “live” content including national content feeds, and video-on-demand content.

Acquired content is provided to a content delivery server 160 via backbone network 170 and switch 140. Content may be delivered from content delivery server 160 to clients 120 via switch 140 and access network 130. Content may be compressed, encrypted, modulated, demodulated, and otherwise encoded or processed at content acquisition resources 180, content delivery server 160, or both. Although FIG. 1 depicts a single element encompassing acquisition of all content, different types of content may be acquired via different types of acquisition resources. Similarly, although FIG. 1 depicts a single content delivery server 160, different types of content may be delivered by different servers. Moreover, embodiments of multimedia content delivery network 100 may include content acquisition resources in regional offices that are connected to switch 140.

Although the service provider 121 is depicted in FIG. 1 as having a single switch 140 to which content acquisition resources 180, content delivery server 160, and application server 150 are connected, other embodiments may employ different switches for each of these functional components and may include additional functional components not depicted in FIG. 1 including, for example, operational subsystem support (OSS) resources.

FIG. 1 illustrates application server 150 connected to switch 140. As suggested by its name, application server 150 may host or otherwise implement one or more applications for multimedia content delivery network 100. Applications provided by application server 150 may be downloaded and hosted on other network resources including, for example, content delivery server 160, switch 140, CPE 122, and/or MHD 125. The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

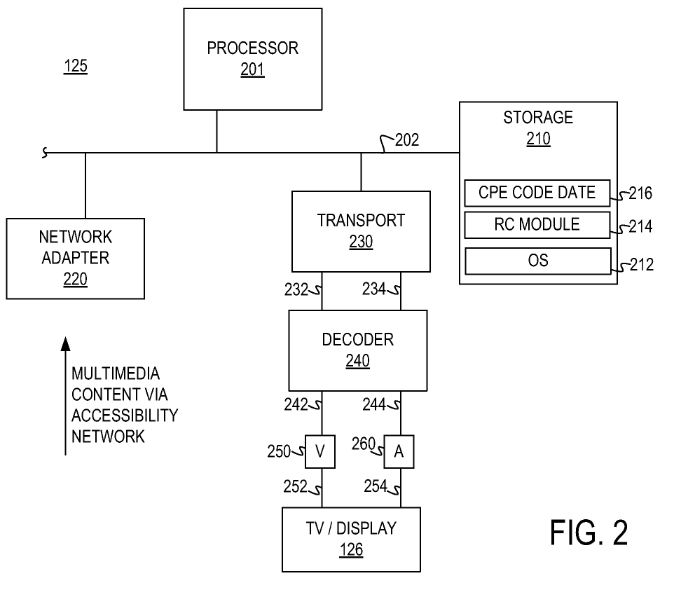

Referring to FIG. 2, a block diagram illustrating selected elements of an embodiment of MHD 125 is presented. In the depicted embodiment, MHD 125 includes a general purpose processor 201 coupled via a shared bus 202 to storage media collectively identified as storage 210. MHD 125 as depicted in FIG. 2 further includes a network adapter 220 that interfaces MHD 125 to LAN 124 and through which MHD 125 receives multimedia content. In embodiments suitable for use in IP based content delivery networks, MHD 125, as depicted in FIG. 2, may include a transport unit 230 that assembles the payloads from a sequence or set of network packets into a stream of multimedia content. In coaxial based access networks, content may be delivered as a stream that is not packet based and it may not be necessary in these embodiments to include transport unit 230. In a co-axial implementation, however, clients 120 may require tuning resources (not explicitly depicted in FIG. 1) to “parse” desired content from other content that is delivered over the coaxial medium simultaneously and these tuners may be provided in MHDs 125. The stream of multimedia content received by transport unit 230 may include audio information and video information and transport unit 230 may parse or segregate the two to generate a video stream 232 and an audio stream 234 as shown.

Video and audio streams 232 and 234, as output from transport unit 230, may include audio or video information that is compressed, encrypted, or both. A decoder unit 240 is shown as receiving video and audio streams 232 and 234 and generating native format video and audio streams 242 and 244. Decoder 240 may employ any of various widely distributed video decoding algorithms including any of the Motion Pictures Expert Group (MPEG) standards, Windows Media Video (WMV) standards including WMV 9, which has been standardized as Video Codec-1 (VC-1) by the Society of Motion Picture and Television Engineers. Similarly decoder 240 may employ any of various audio decoding algorithms including Dolby® Digital, Digital Theatre System (DTS) Coherent Acoustics, and Windows Media Audio (WMA).

The native format video and audio streams 242 and 244 as shown in FIG. 2 may be processed by encoders/digital-to-analog converters (encoders/DACs) 250 and 260 respectively to produce analog video and audio signals 252 and 254 in a format compliant with display 126, which itself may not be a part of MHD 125. Display 126 may comply with NTSC, PAL or any other suitable television standard.

Storage 210 encompasses persistent and volatile media, fixed and removable media, and magnetic and semiconductor media. Storage 210 is operable to store instructions, data, or both. Storage 210 as shown includes sets or sequences of instructions, namely, an operating system 212 and an application program identified as RC module 214. Storage 210 as depicted further includes a data referred to as CPE action code data. Operating system 212 may be a Unix or Unix-like operating system, a Windows® family operating system, or another suitable operating system.

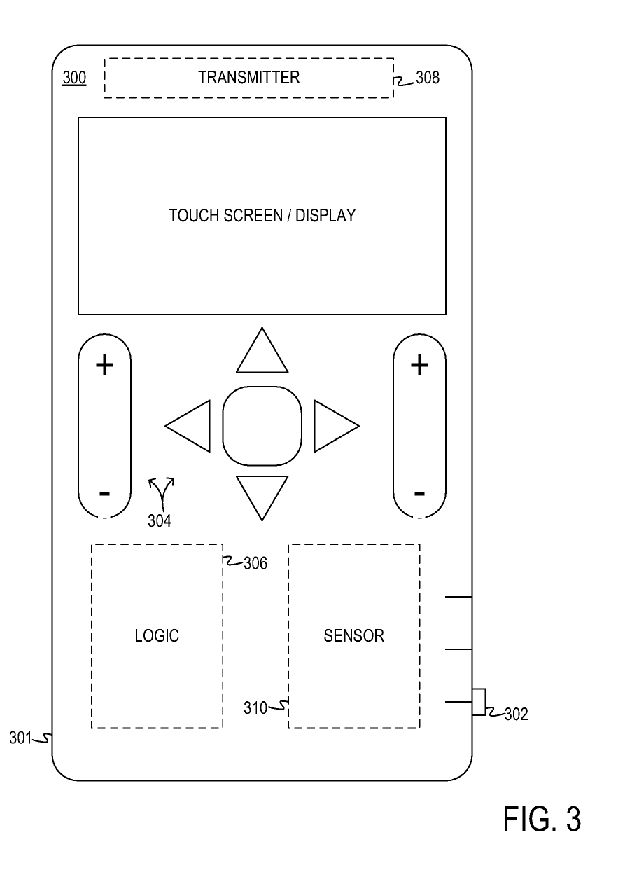

Referring briefly to FIG. 3, selected elements of an embodiment of a remote control device 300 are illustrated. The depicted embodiment of remote control device 300 includes an N-state switchable control 302 where N is a variable having a value greater than 1. Remote control device 300 as shown further includes a set of action controls 304 and data generation logic 306. Data generation logic 306 may respond to an assertion of an action control 304 by generating remote control data based on the specific action control 304 that was asserted and a state of N-state switchable control 302. A transmitter 308 may modulate the remote control data onto a remote control carrier signal and transmit the modulated remote control carrier signal. Switchable control 302 may be a physical switch or a “soft” switch. In the case of a physical switch, the physical switch may be recessed within a housing 301 of remote control device 300 or otherwise located where the physical switch is not easily asserted.

Some embodiments of remote control device 300 may include a sensor 310 to detect a biometric characteristic of a user. In these embodiments, a state of N-state switchable control 302 may reflect a biometric characteristic detected by sensor 310. The remote control data generated by logic 306 may include a numeric action code based on the asserted action control and a numeric identification code based on a state of the N-state switchable control. The modulated remote control carrier signal generated by transmitter 308 may include an action code portion indicative of the action code and an identification portion indicative of the identification code.

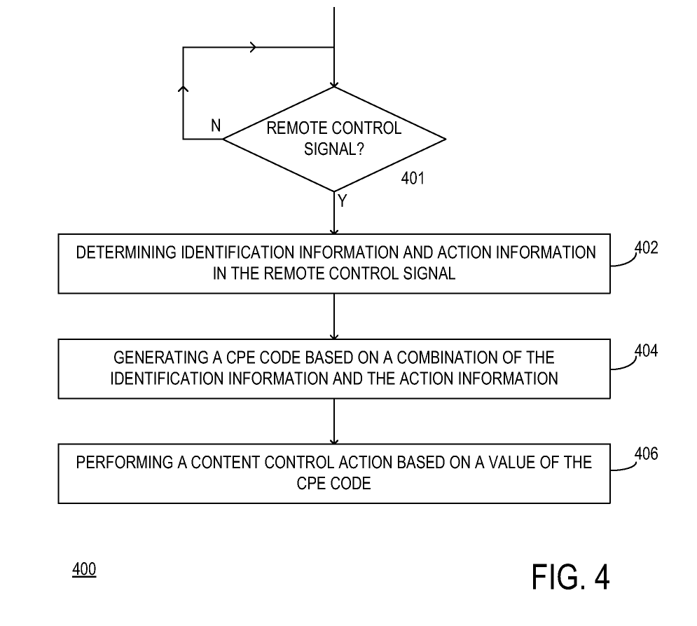

Referring now to FIG. 4, selected operations in an embodiment of a method 400 for controlling access to content provided by a MCDN is depicted. In the depicted embodiment, method 400 includes detecting (operation 401) a remote control signal and identifying (block 402) identification information and action information in the remote control signal. A CPE code is then generated (operation 404) based on a combination of the identification information and the action information. Method 400 as shown further includes performing (block 406) a content control action based on a value of the CPE code.

The identification information may be indicative of a setting of a switchable control of a remote control device or a user of the remote control device. In some embodiments, the method includes generating a CPE code corresponding to the action information when the identification information is indicative of a first user and performing a null action when the identification information is indicative of a second user. Generating the CPE code may include generating a first CPE code when the identification information is indicative of a first user and generating a second CPE code, different than the first CPE code, when the identification information is indicative of a second user. Generating a CPE code may also include querying a database of CPE codes using the identification information and the action information as query parameters. Generating the CPE code may still further include accessing parental control restrictions associated with a user or user class indicated by the identification information. Generating the CPE code may include generating a CPE code in compliance with the parental control restrictions.

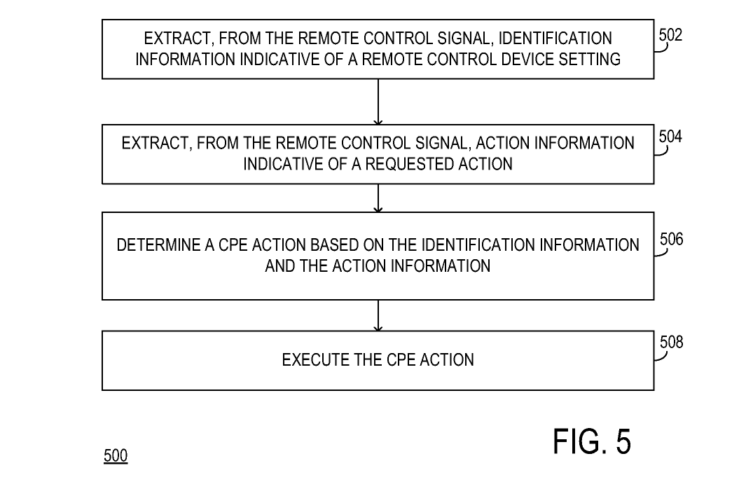

Referring now to FIG. 5, exemplary operations performed by MHD 125 are illustrated as a method 500. In the depicted embodiment, method 500 includes extracting (operation 502), from the remote control signal, identification information indicating a setting of a remote control device and extracting (operation 504), from the remote control signal, action information indicative of a requested action. The operations performed by CPE 122 may further include determining (operation 506) a CPE action based on the identification information and the action information and executing (operation 508) the CPE action.

The operations may further include operations to generate a CPE code corresponding to the CPE action. The storage media may further include CPE code data. The CPE code data may be suitable for determining the CPE code corresponding to a CPE action. The instructions to generate the CPE code may include instructions to access the CPE code data structure using the CPE action. The instructions to determine a CPE action may include instructions to determine a null action as the CPE action when the identification information has a first value. The identification information may convey the identity of a remote control device, a state of an N-state switchable control of the remote control device, or a user category of a user of the remote control device. The user categories may include an adult category and a child category. Determining the CPE action may include accessing parental control information when the user category is the child category and identifying a CPE action complying with the parental control information.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for controlling access to content provided by a multimedia content delivery network, comprising:
responsive to detecting a remote control signal, identifying identification information and action information in the remote control signal;
generating a customer premises equipment (CPE) code based on a combination of the identification information and the action information; and
performing a content control action based on a value of the CPE code.

2. The method of claim 1, wherein the identification information is indicative of a setting of a remote control switch.

3. The method of claim 1, wherein the identification information is indicative of a user of a remote control device generating the remote control signal.

4. The method of claim 3, wherein the content control action is selected from a group of actions including a null action and further wherein generating the CPE code comprises:
generating a CPE code corresponding to the action information when the identification information is indicative of a first user; and
performing the null action when the identification information is indicative of a second user.

5. The method of claim 3, wherein the generating of a CPE code comprises:
generating a first CPE code when the identification information is indicative of a first user; and
generating a second CPE code, different than the first CPE code, when the identification information is indicative of a second user.

6. The method of claim 1, wherein the generating of a CPE code comprises querying a database of CPE codes using the identification information and the action information as query parameters.

7. The method of claim 1, wherein the generating of a CPE code includes:
accessing parental control restrictions associated with a user associated with the identification information; and
generating a CPE code in compliance with the parental control restrictions.

8. A customer premises equipment (CPE) device, comprising:
a processor;
a network interface to receive encoded multimedia content;
a multimedia decoder to decode the encoded multimedia content;
a remote control interface to receive and process a remote control signal transmitted by a remote control; and
storage media embedding processor executable instructions, the instructions comprising instructions to:
extract, from the remote control signal, identification information indicative of a remote control device setting;
extract, from the remote control signal, action information indicative of a requested action;
determine a CPE action based on the identification information and the action information; and
execute the CPE action.

9. The device of claim 8, wherein the instructions further comprise instructions to generate a CPE code corresponding to the CPE action.

10. The device of claim 9, wherein the storage media further includes CPE code data, wherein the CPE code data is suitable for determining the CPE code corresponding to a CPE action, and further wherein the instructions to generate the CPE code comprise instructions to access the CPE code data structure using the CPE action.

11. The device of claim 8, wherein the instructions to determine a CPE action include instructions to determine a null action as the CPE action when the identification information has a first value.

12. The device of claim 8, wherein the identification information is indicative of an identity of the remote control device.

13. The device of claim 8, wherein the identification information is indicative of a state of an N-state switchable control of the remote control device.

14. The device of claim 8, wherein the identification information is indicative of a user category of a user of the remote control device.

15. The device of claim 14, wherein the user category is selected from the group of user categories including an adult category and a child category.

16. The device of claim 15, wherein the instructions to determine the CPE action include instructions to:
access parental control information when the user category is the child category; and
identify a CPE action complying with the parental control information.

17. A remote control device, comprising:
an N-state switchable control, wherein N is greater than 1;
an action control;
data generation logic configured to respond to an assertion of the action control, by generating remote control data based on the action control asserted and a state of the N-state switchable control; and
a transmitter operable to modulate the remote control data onto a remote control carrier signal and transmit the modulated remote control carrier signal.

18. The device of claim 17, wherein the N-state switchable control is a physical switch.

19. The device of claim 18, wherein the physical switch is recessed within a housing of the remote control device.

20. The device of claim 17, further comprising a sensing device operable to detect a biometric characteristic of a user of the remote control.

21. The device of claim 20, wherein a state of the N-state switchable control is responsive to the biometric characteristic detected by the sensing device.

22. The device of claim 17, wherein the remote control data includes a numeric action code based on the asserted action control and a numeric identification code based on a state of the N-state switchable control.

23. The device of claim 22, wherein the modulated remote control carrier signal includes an action code portion indicative of the action code and an identification portion indicative of the identification code.
